(19) United States
(12) Patent Application Publication
(10) Pub. No.: US 2009/0014913 A1
(43) Pub. Date: Jan. 15, 2009

(54) METHOD FOR FABRICATING LENS OF LIGHT EMITTING DIODE AND DEVICE THEREOF

(75) Inventors: Jung-Chuan Lin, Jhonghe City (TW); Chung-Chuan Hsieh, Panchiao City (TW)

Correspondence Address: PAI PATENT & TRADEMARK LAW FIRM, 1001 FOURTH AVENUE, SUITE 3200, SEATTLE, WA, 98154, US

(73) Assignee: EVERLIGHT ELECTRONICS CO., LTD., Tu Chen City (TW)

(21) Appl. No.: 11/868,426

(22) Filed: Oct. 5, 2007

(30) Foreign Application Priority Data
Jul. 11, 2007 (TW) 96125281

(51) Int. Cl. B29C 33/68

(52) U.S. Cl. 264/317; 425/89

(57) ABSTRACT

A method for fabricating lens of light emitting diode and device thereof is disclosed, and the method includes providing a lead frame with multiple light emitting diode modules, positioning a mold releasing member on the lead frame, connecting a lens pattern device with the lead frame, injecting a resin into each lens mold, and curing the resin to lenses on the light emitting diodes modules.

### CROSS-REFERENCE TO RELATED APPLICATION

This application claims the priority benefit of Taiwan application serial no. 96125281, filed Jul. 11, 2007, the full disclosure of which is incorporated herein by reference.

### BACKGROUND

1. Field of Invention

The present invention relates to a method for fabricating the lens of light emitting diode (LED), and more particularly to the method for fabricating the lens of light emitting diode through a lens pattern device.

2. Description of Related Art

Light emitting diodes have high reaction speeds, smaller volumes, lower power consumption, less heat radiation and extended lifetimes and have therefore gradually replaced conventional incandescent or halogen lamps. Applications for light emitting diodes, like the indication light for electronic apparatus, the back light source of the liquid crystal display (LCD) and the illuminator, are continually being extended as technology progresses.

During the packaging process, the LED module generally includes a lens thereon to enhance the light condensing effect. The conventional lens forming method includes covering a lens on the LED module and injecting a packaging gel to contain the LED chip to protect the LED chip and raise the light condensing effect.

However, the packaging gel in this step is fused with the lens through a thermal melt-joint feature of the packaging gel. Consequently, the refractive index difference between the packaging gel and the lens deteriorates the light condensing effect of the LED module. In addition, this step of covering the lens and injecting the packaging gel not only raises the cost but also extends the period of the LED packaging process.

As a result, developing another lens forming method with lower cost and a shorter period to apply the LED packaging process to satisfy the increasing demand on the market becomes the aim of the researchers.

### SUMMARY

It is therefore an aspect to provide a method for fabricating lens of light emitting diode to simplify the lens forming step in packaging process and shorten the period thereof.

It is therefore another aspect to provide a method for fabricating lens of light emitting diode to solve the light condensing problem resulting from the refractive index difference between the packaging gel and the lens.

It is therefore another aspect to provide a method for fabricating lens of light emitting diode to reduce the cost by reusing the mold to shape the lens formation.

In accordance with an embodiment of the present invention, the method for fabricating lens of light emitting diode includes providing a lead frame, positioning a mold releasing member on the lead frame, connecting a lens pattern device with the lead frame, injecting a resin into the lens pattern device and curing the resin to the lens on the light emitting diode modules.

The lead frame includes a plurality of light emitting diode modules. The mold releasing member includes a hollow area corresponding to the light emitting diode modules of the lead frame to expose the light emitting diode modules. The lens pattern device includes a plurality of lens molds wherein each of the light emitting diode modules is jointed within each of the lens molds tightly through the connection between the lens pattern device and the lead frame. Each of the lens molds has two holes allowing resin to be injected into the cavity defined by the connection between each of the lens molds and each of the light emitting diode modules through one of the holes. Curing the resin by baking the assembled lead frame, mold releasing member and lens pattern device to shape the resin filled with the cavity to lens on each of the light emitting diode modules.

Compared to the conventional light emitting diode packaging process, applying the method for fabricating lens of light emitting diode of the present invention has the following effects:

1. The method for fabricating lens of light emitting diode utilizes the lens pattern device to simplify the lens forming step and shorten the period thereof.

2. The method for fabricating lens of light emitting diode reuses the lens pattern device to shape the lens formation to reduce the cost and solve the light condensing problem resulted from the refractive index difference between the packaging gel and the lens.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention. In the drawings,

FIG. 1 is a flow chart of the method for fabricating lens of light emitting diode in accordance with the present invention;

FIG. 2 is an exploded structure view of an embodiment for the method in accordance with FIG. 1;

FIG. 3 is an assembly structure view of the embodiment for the method in accordance with FIG. 1;

FIG. 4 is an assembly sectional view of the embodiment of the method in accordance with FIG. 1; and

FIG. 5 is a perspective view of a single LED module after cutting process in accordance with FIG. 1.

### DESCRIPTION OF THE PREFERRED EMBODIMENTS

Reference will now be made in detail to the present preferred embodiments of the invention, examples of which are illustrated in the accompanying drawings. Wherever possible, the same reference numbers are used in the drawings and the description to refer to the same or like parts.

While the specification concludes with claims defining the features of the invention that are regarded as novel, it is believed that the invention will be better understood from a consideration of the following description in conjunction with the figures, in which like reference numerals are carried forward.

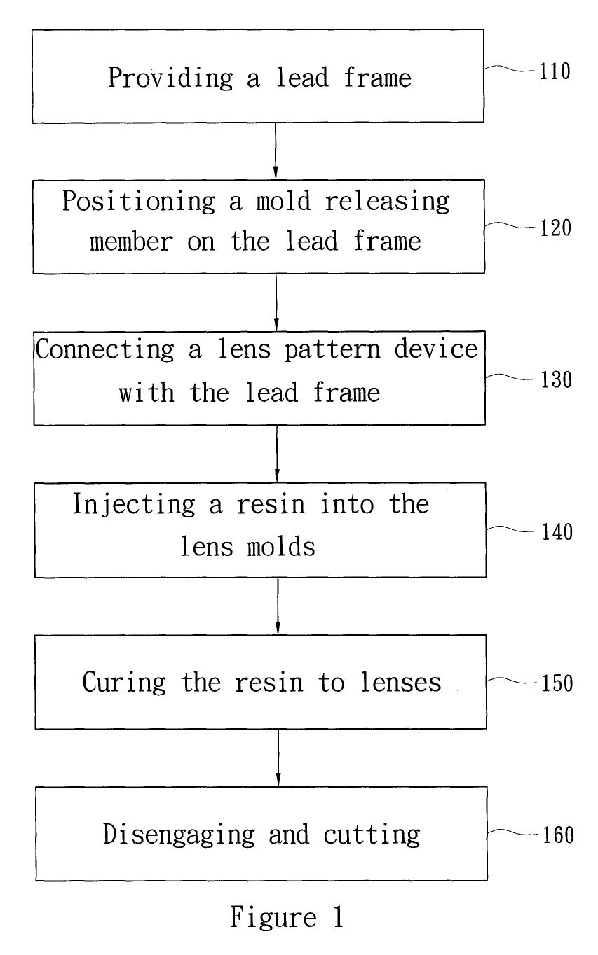

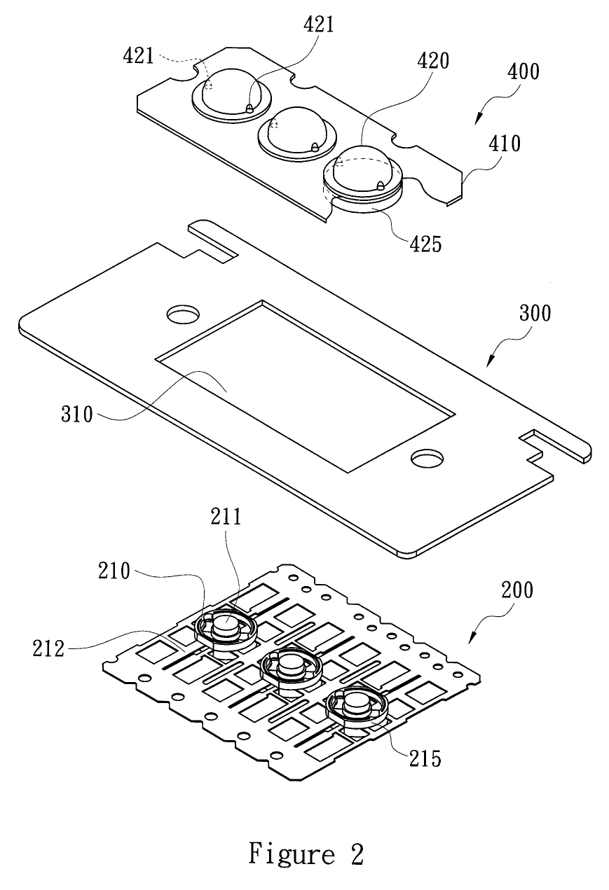

Refer to FIG. 1 and FIG. 2. FIG. 1 illustrates a flow chart of the method for fabricating the lens of light emitting diode in accordance with the present invention; FIG. 2 illustrates an exploded structure view of an embodiment for the method in accordance with FIG. 1.

The method for fabricating the lens of light emitting diode includes providing a lead frame with multiple light emitting diode modules, positioning a mold releasing member on the lead frame, connecting a lens pattern device with the lead frame, injecting a resin into the lens pattern device and curing the resin to lenses on the light emitting diode modules.

The lead frame 200 includes a plurality of light emitting diode modules 210 wherein each of the light emitting diode modules 210 has a die area 211, a finger area 212 and a first joint portion 215. The LED chip is mounted on the die area 211 and connected electrically with the finger area 212 through wire bonding process. The mold releasing member 300 includes a hollow area 310 corresponding to the light emitting diode modules 210 of the lead frame 200 to expose the light emitting diode modules 210 when the mold releasing member 300 is placed on the lead frame 200. The lens pattern device 400 includes a substrate 410 and a plurality of lens molds 420 mounted on the substrate 410. Each of the lens molds 420 has a cavity 213, two holes 421 and a second joint portion 425. The holes 421 are positioned symmetrically on the lens mold 420 and communicate with the cavity 213 wherein one of the holes 421 is the injecting hole, and the other hole 421 is the exhausting hole. In addition, the first joint portion 215 of each of the light emitting diode modules 210 has a first diameter less than a second diameter of the second joint portion 425 of each of the lens molds 420 so that the second joint portion 425 can joint with the first joint portion 215. In this embodiment, the light emitting diode modules 210 and the lens molds 420 are respectively disclosed with three pieces for illustration, and the amount should not limit the scope of the invention.

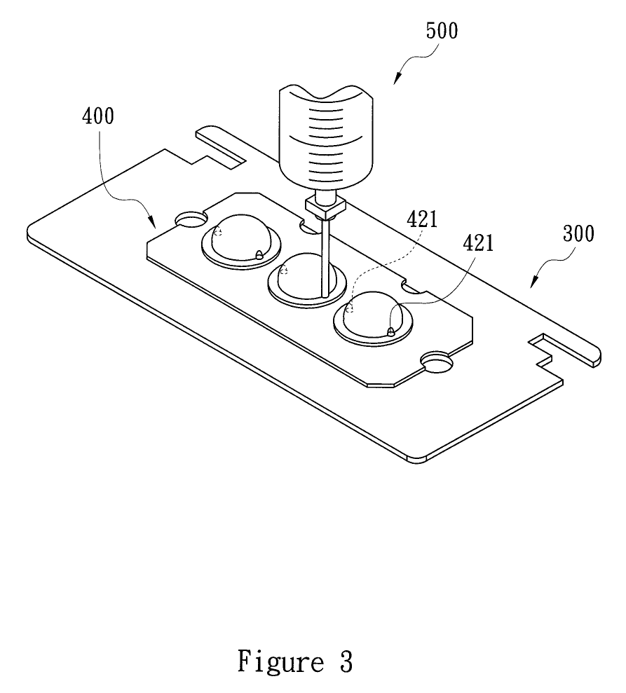

Refer to FIG. 1, FIG. 3 and FIG. 5. FIG. 3 illustrates an assembly structure view of the embodiment for the method in accordance with FIG. 1; FIG. 5 illustrates a perspective view of a single LED module after the cutting process in accordance with FIG. 1.

In step 110, providing the lead frame 200 on which the light emitting diode modules 210 are mounted.

In step 120, positioning the mold releasing member 300 on the lead frame 200 to expose the light emitting diode modules 210 of the lead frame 200 through the hollow area 310 of the mold releasing member 300. The mold releasing member 300 may be a steel sheet.

In step 130, connecting the lens pattern device 400 with the lead frame 200 such that each of the light emitting diode modules 210 is jointed with each of the lens molds 420 tightly through the connection between the first joint portion 215 and the second joint portion 425.

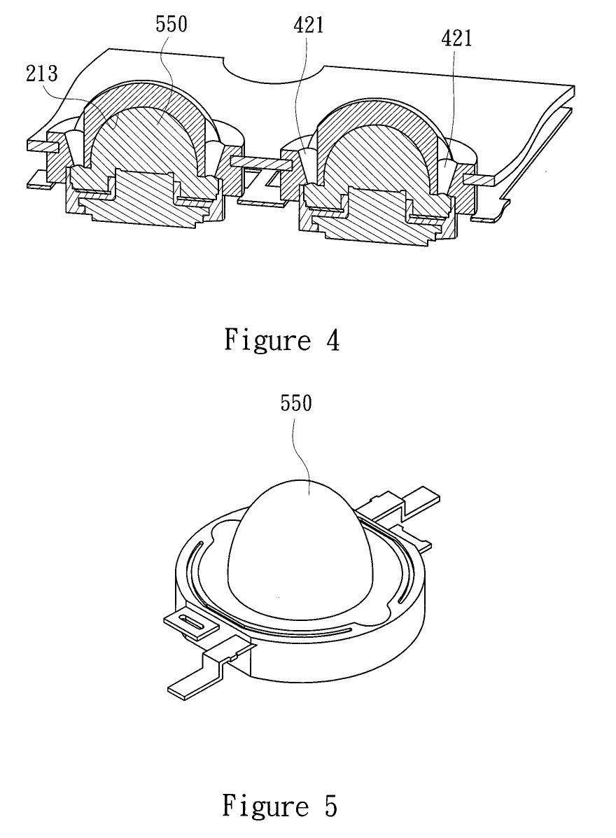

In step 140, injecting the resin 550 into the cavity 213 defined by the connection between each of the lens molds 420 and each of the light emitting diode modules 210 through the injecting hole 421 by using a dispensing syringe 500. Consequently, the cavity 213 is filled with the resin 550 completely (Refer to FIG. 4).

In step 150, curing the resin 550 by baking the assembled lead frame 200, mold releasing member 300 and lens pattern device 400 to a predetermined temperature to shape the resin 550 filled in the cavity 213 to form a lens on each of the light emitting diode modules 210.

In step 160, disengaging the lens pattern device 400 and the lead frame 200 by the mold releasing member 300 and cutting the lead frame 200 to divide into multiple separated light emitting diode modules 210.

The injected resin 550 in step 140 is silicon resin, epoxy resin, poly carbonate or other suitable material for the lens of the light emitting diode device. In addition, the injected resin 550 can be added with various phosphors to generate emitted light of different optical color in accordance with the product design requirement.

As embodied and broadly described herein, applying the method for fabricating lens of light emitting diode of the present invention has the following effects:

1. The method for fabricating lens of light emitting diode utilizes the lens pattern device 400 to simplify the lens forming step and shorten the period thereof.

2. The method for fabricating lens of light emitting diode reuses the lens pattern device 400 to shape the lens to reduce the cost and solve the light condensing problem resulting from the refractive index difference between the packaging gel and the lens.

Although the present invention has been described in considerable detail with reference to certain preferred embodiments thereof, other embodiments are possible. Therefore, the spirit and scope of the appended claims should not be limited to the description of the preferred embodiments contained herein.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A method for fabricating a lens of a light emitting diode, comprising:
providing a lead frame comprising a plurality of light emitting diode modules;
positioning a mold releasing member on the lead frame wherein the mold releasing member comprises a hollow area to expose the light emitting diode modules;
connecting a lens pattern device with the lead frame wherein the lens pattern device comprises multiple lens molds, and each of the lens molds corresponds to each of the light emitting diode modules and comprises a cavity and two holes communicated with the cavity;
injecting a resin into each of the lens molds through one of the holes; and
curing the resin to form a lens on each of the light emitting diode modules.

2. The method of claim 1, further comprising:
disengaging the lens pattern device and the lead frame by the mold releasing member; and
cutting the lead frame to divide into multiple separated light emitting diode modules.

3. The method of claim 1, wherein each of the light emitting diode modules comprises a first joint portion with a first diameter, and each of the lens molds comprises a second joint portion with a second diameter wherein the first diameter is less than the second diameter whereby each of the light emitting diode modules is jointed within each of the lens molds tightly.

4. The method of claim 1, wherein the resin is injected into each of the lens molds through one of the holes by a dispensing syringe.

5. The method of claim 1, wherein the holes comprise an injecting hole and an exhausting hole.

6. The method of claim 1, wherein the mold releasing member is a steel sheet.

7. The method of claim 1, wherein the injected resin is silicon resin.

8. The method of claim 1, wherein the injected resin is epoxy resin.

9. The method of claim 1, wherein the injected resin is poly carbonate.

10. The method of claim 1, wherein the injected resin is added with a phosphor.

11. A lens pattern device, comprising:
a substrate; and
a plurality of lens molds mounted on the substrate wherein each of the lens molds comprises two holes for injecting a resin.

12. The lens pattern device of claim 11, wherein the holes comprises an injecting hole and an exhausting hole.
